(19) United States
(12) Patent Application Publication
(10) Pub. No.: US 2026/0056659 A1
(43) Pub. Date: Feb. 26, 2026

(54) ELECTRONIC DEVICE AND COMPUTING SYSTEM INCLUDING SAME

(71) Applicant: XCENA Inc., Seongnam-si (KR)

(72) Inventors: Ju Hyun KIM, Seongnam-si (KR); Jae Wan YEON, Seongnam-si (KR)

(73) Assignee: XCENA Inc., Seongnam-si (KR)

(21) Appl. No.: 19/305,393

(22) Filed: Aug. 20, 2025

(30) Foreign Application Priority Data
Aug. 26, 2024 (KR) 10-2024-0114648

(51) Int. Cl. G06F 3/06

(52) U.S. Cl. CPC G06F 3/0608; G06F 3/0659; G06F 3/0673

(57) ABSTRACT

An electronic device includes a host processor, a volatile memory configured to store a plurality of compressed data, and a controller configured to be connected to the host processor and the volatile memory, wherein the controller is configured to generate a deduplication table that stores hash values associated with respective ones of the plurality of compressed data, identify, based on the deduplication table, first compressed data and second compressed data among the plurality of compressed data that correspond to each other, and delete one of the first compressed data and the second compressed data from the volatile memory.

### CROSS-REFERENCE TO RELATED APPLICATION

This application claims priority to Korean Patent Application No. 10-2024-0114648, filed in the Korean Intellectual Property Office on Aug. 26, 2024, the entire contents of which are hereby incorporated by reference.

### BACKGROUND

### Field

The present disclosure relates to an electronic device and a computing system including the same.

### Description of Related Art

A memory (e.g., DRAM) directly connected to a host CPU is fast but is a very expensive and capacity-limited resource. For this reason, various techniques are used to maximize the utilization of the host memory. For example, a method is utilized that allows a page to be used for other purposes by storing pages that are not frequently used or for which there has been no recent access request among the memory areas used by an application program to a storage (swap-out).

However, in the process of performing this method, if the same page is loaded into memory multiple times and then swapped out, a duplicate storage problem may occur where the same page is stored duplicately in the storage. This duplicate storage problem has the issue of inefficiently using storage and input/output resources.

### SUMMARY

The present disclosure provides an electronic device and a computing system including the same for solving the problems as described above.

The present disclosure may be implemented in various ways, including a device, a system, a method, or a computer program stored on a readable storage medium.

In some embodiments, an electronic device may include a host processor, a volatile memory configured to store a plurality of compressed data, and a controller configured to be connected to the host processor and the volatile memory, wherein the controller is configured to generate a deduplication table that stores hash values associated with respective ones of the plurality of compressed data, identify, based on the deduplication table, first compressed data and second compressed data among the plurality of compressed data that correspond to each other, and delete one of the first compressed data and the second compressed data from the volatile memory.

In some embodiments, the deduplication table may include a first hash value associated with the first compressed data and a second hash value associated with the second compressed data, the controller is configured to determine whether the first hash value and the second hash value are identical, and in response to determining that the first hash value and the second hash value are identical, delete one of the first compressed data and the second compressed data from the volatile memory.

In some embodiments, the controller is configured, in response to determining that the first hash value and the second hash value are identical, to determine whether the first compressed data and the second compressed data are identical, and in response to determining that the first compressed data and the second compressed data are identical, delete one of the first compressed data and the second compressed data from the volatile memory.

In some embodiments, the deduplication table may include a first counter value for the first compressed data, the controller is configured, in response to determining to delete the second compressed data, to increment the first counter value, delete the second compressed data, and delete information about the second compressed data stored in the deduplication table.

In some embodiments, the deduplication table may include a first entry for the first compressed data and a second entry for the second compressed data, the first entry may include a first page address value, a first hash value, and a first counter value for the first compressed data, and the second entry may include a second page address value, a second hash value, and a second counter value for the second compressed data.

In some embodiments, the controller is configured to compare the first hash value and the second hash value and determine that the first hash value and the second hash value are identical, compare the first counter value and the second counter value and determine that the second counter value is less than the first counter value, delete the second compressed data from the volatile memory, increment the first counter value, and delete the second entry from the deduplication table.

In some embodiments, the controller is configured, in response to a swap-out request for first data in units of pages received from the host processor, to store, at a first page address value of the volatile memory, first compressed data generated by compressing the first data, in response to a swap-out request for second data in units of pages received from the host processor, to store, at a second page address value of the volatile memory, second compressed data generated by compressing the second data, record the first page address value in metadata of the first data, and record the second page address value in metadata of the second data.

In some embodiments, the controller is configured to delete the second compressed data among the first compressed data and the second compressed data, and, based on the deduplication table, change metadata of the second data from the second page address value to the first page address value.

In some embodiments, the controller is configured, in response to a swap-out request for the first data, to generate a hash value for the first data and store the hash value in the deduplication table, and, in response to a swap-out request for the second data, generate a hash value for the second data and store the hash value in the deduplication table.

In some embodiments, the controller is configured to generate, at intervals of a first period, the hash value for the first data or the hash value for the second data, and, at intervals of a second period different from the first period, identify, based on the deduplication table, compressed data among the plurality of compressed data that corresponds to the first compressed data or the second compressed data.

In some embodiments, the deduplication table may include a third entry that may include a third page address value, a third hash value, and a third counter value for third compressed data, the controller is configured to receive, from the host processor, a swap-in request for the third compressed data stored in the volatile memory, in response to the swap-in request, provide to the host processor third data generated by decompressing the third compressed data, and change the third counter value included in the deduplication table.

In some embodiments, the controller is configured to delete the third entry included in the deduplication table in response to changing the third counter value to 0.

In some embodiments, the controller is further connected to a nonvolatile memory, and the deduplication table stores hash values and page address values associated with respective ones of a plurality of compressed data stored in the nonvolatile memory.

In some embodiments, the controller is configured to determine, based on the deduplication table, whether fourth compressed data stored in the volatile memory is identical to fifth compressed data stored in the nonvolatile memory, and, in response to determining that the fourth compressed data is identical to the fifth compressed data, set a candidate flag of the fourth compressed data included in the deduplication table.

In some embodiments, the controller is configured to determine whether a predetermined time has elapsed after the candidate flag of the fourth compressed data is set, and, in response to determining that the predetermined time has elapsed, delete the fourth compressed data from the volatile memory, delete information about the fourth compressed data included in the deduplication table, and change, based on the deduplication table, metadata associated with the fourth compressed data.

In some embodiments, the controller is configured to determine at least one cold data item among the plurality of compressed data stored in the volatile memory and move the cold data from the volatile memory to the nonvolatile memory.

In some embodiments, the volatile memory is divided into a compressed memory pool and a temporary memory pool, and the controller is configured to manage, based on information included in the deduplication table, data stored in the compressed memory pool.

In some embodiments, a computing system may include a host processor, and an electronic device, wherein the electronic device may include a volatile memory configured to store a plurality of compressed data, and a controller configured to generate a deduplication table that stores hash values associated with respective ones of the plurality of compressed data, identify, based on the deduplication table, first compressed data and second compressed data among the plurality of compressed data that correspond to each other, and delete one of the first compressed data and the second compressed data from the volatile memory.

According to various embodiments of the present disclosure, one of a plurality of corresponding compressed data stored in a volatile memory may be deleted based on a deduplication table. Accordingly, a duplicate storage problem where the same data is stored duplicately may be prevented, and memory and input/output resources may be used efficiently.

According to various embodiments of the present disclosure, a candidate flag may be set in response to determining that data stored in a nonvolatile memory and data stored in a volatile memory are identical, and the data for which the candidate flag is set may be deleted after a predetermined time has passed. Accordingly, a swap-in request for duplicately stored data may be processed promptly, and at the same time, memory may be managed efficiently.

The effects of the present disclosure are not limited to the effects mentioned above, and other unmentioned effects will be clearly understood by those of ordinary skill in the art to which the present disclosure pertains (hereinafter, ‘person of ordinary skill in the art’) from the description of the claims.

### BRIEF DESCRIPTION OF THE DRAWINGS

FIG. 1 is a conceptual exemplary diagram illustrating a computing system including an electronic device according to an embodiment of the present disclosure.

FIG. 2 is a block diagram of a computing system including an electronic device according to an embodiment of the present disclosure.

FIG. 3 is a block diagram of a controller included in an electronic device according to an embodiment of the present disclosure.

FIG. 4 is a block diagram of a controller included in an electronic device according to another embodiment of the present disclosure.

FIG. 5 is a diagram for explaining a deduplication table according to an embodiment of the present disclosure.

FIG. 6 is a diagram for explaining an operation in which a controller processes a swap-out request according to an embodiment of the present disclosure.

FIG. 7 is a flowchart regarding an operation in which a controller determines whether to perform data deduplication according to an embodiment of the present disclosure.

FIG. 8 is a diagram for explaining an operation in which a controller performs data deduplication according to an embodiment of the present disclosure.

FIG. 9 is a diagram for explaining an operation in which a controller processes a swap-in request according to an embodiment of the present disclosure.

FIG. 10 is a diagram for explaining an operation in which a controller sets a candidate flag according to an embodiment of the present disclosure.

FIG. 11 is a diagram for explaining an operation in which a controller performs data deduplication on compressed data for which a candidate flag is set, according to an embodiment of the present disclosure.

FIG. 12 is a conceptual exemplary diagram illustrating a computing system including an electronic device according to another embodiment of the present disclosure.

### DETAILED DESCRIPTION

The various embodiments described in this specification are illustrated for the purpose of clearly explaining the technical idea of the present disclosure, and are not intended to limit the technical idea to a specific embodiment. The technical idea of the present disclosure includes various modifications, equivalents, alternatives of each embodiment described in this specification, and embodiments selectively combined from all or part of each embodiment. In addition, the scope of rights of the technical idea of the present disclosure is not limited to the various embodiments presented below or the detailed description thereof.

Unless defined otherwise, terms used in this specification, including technical or scientific terms, may have the meanings generally understood by a person of ordinary skill in the art to which the present disclosure pertains.

Expressions such as “include,” “may include,” “have,” “may have,” “possess,” “may possess,” etc., used in this specification mean the existence of a subject feature (e.g., function, operation, or component, etc.) and do not exclude the existence of other additional features. That is, such expressions should be understood as open-ended terms implying the possibility of including other embodiments.

In this specification, a singular expression includes a plural expression unless the context clearly indicates a singular expression. Also, a plural expression includes a singular expression unless the context clearly indicates a plural expression. Throughout the specification, when a part is said to include a certain component, this means that it may further include other components, not excluding other components, unless there is a specific statement to the contrary.

In addition, the term ‘module’ or ‘unit’ used in the specification means a software or hardware component, and the ‘module’ or ‘unit’ performs certain roles. However, the ‘module’ or ‘unit’ is not limited to software or hardware. A ‘module’ or ‘unit’ may be configured to be in an addressable storage medium and may be configured to reproduce one or more processors. Thus, as an example, a ‘module’ or ‘unit’ may include at least one of components such as software components, object-oriented software components, class components, and task components, and processes, functions, attributes, procedures, subroutines, segments of program code, drivers, firmware, microcode, circuits, data, databases, data structures, tables, arrays, or variables. The functions provided within the components and ‘modules’ or ‘units’ may be combined into a smaller number of components and ‘modules’ or ‘units’ or further separated into additional components and ‘modules’ or ‘units’.

According to an embodiment of the present disclosure, a ‘module’ or ‘unit’ may be implemented as a processor and a memory. A ‘processor’ should be broadly interpreted to include a general-purpose processor, a central processing unit (CPU), a microprocessor, a digital signal processor (DSP), a controller, a microcontroller, a state machine, and the like. In some environments, a ‘processor’ may also refer to an application-specific integrated circuit (ASIC), a programmable logic device (PLD), a field-programmable gate array (FPGA), and the like. A ‘processor’ may also refer to a combination of processing devices, such as, for example, a combination of a DSP and a microprocessor, a combination of a plurality of microprocessors, a combination of one or more microprocessors combined with a DSP core, or any other such configuration. In addition, a ‘memory’ should be broadly interpreted to include any electronic component capable of storing electronic information. A ‘memory’ may also refer to various types of processor-readable media such as random access memory (RAM), read-only memory (ROM), non-volatile random access memory (NVRAM), programmable read-only memory (PROM), erasable-programmable read-only memory (EPROM), electrically erasable PROM (EEPROM), flash memory, magnetic or optical data storage devices, registers, and the like. A memory is said to be in electronic communication with a processor if the processor can read information from and/or write information to the memory. A memory integrated into a processor is in electronic communication with the processor.

Expressions such as “first,” “second,” or “first,” “second,” etc., used in this specification are used to distinguish one object from another among a plurality of similar objects, unless the context means otherwise, and do not limit the order or importance among the objects.

Expressions such as “A, B, and C,” “A, B, or C,” “A, B, and/or C,” or “at least one of A, B, and C,” “at least one of A, B, or C,” “at least one of A, B, and/or C,” “at least one selected from A, B, and C,” “at least one selected from A, B, or C,” “at least one selected from A, B, and/or C,” etc., used in this specification may mean each listed item or all possible combinations of the listed items. For example, “at least one selected from A and B” may refer to all of (1) A, (2) at least one of A, (3) B, (4) at least one of B, (5) at least one of A and at least one of B, (6) at least one of A and B, (7) at least one of B and A, and (8) A and B.

The expression “based on” as used in this specification is used to describe one or more factors that influence a decision, determination, act, or operation described in the phrase or sentence including the expression, and this expression does not exclude additional factors that influence the decision, determination, act, or operation.

The expression that a certain component (e.g., a first component) is “connected to” or “coupled to” another component (e.g., a second component) used in this specification may mean that the certain component is directly connected or coupled to the other component, as well as being connected or coupled via a new other component (e.g., a third component).

The expression “configured to” used in this specification may have meanings such as “set to,” “having the ability to,” “changed to,” “made to,” “able to,” etc., depending on the context. The expression is not limited to the meaning of “specifically designed in hardware,” and for example, a processor configured to perform a specific operation may mean a generic-purpose processor that can perform that specific operation by executing software.

Hereinafter, various embodiments of the present disclosure will be described with reference to the accompanying drawings. In the accompanying drawings and the description of the drawings, the same or substantially equivalent components may be given the same reference numerals. In addition, in the description of the various embodiments below, redundant description of the same or corresponding components may be omitted, but this does not mean that the corresponding component is not included in that embodiment.

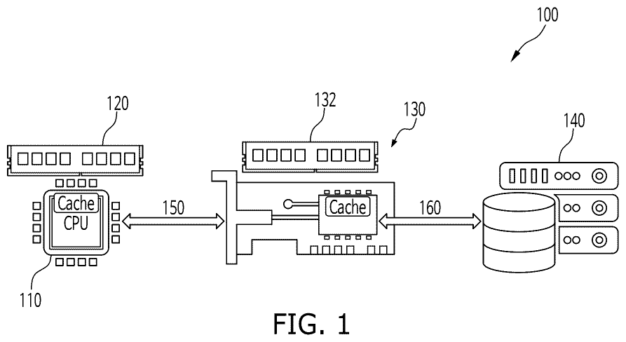

FIG. 1 is a conceptual exemplary diagram illustrating a computing system 100 including an electronic device 130 according to an embodiment of the present disclosure.

A computing system 100 according to the present disclosure may be a storage server or another type of server that may be used in a data center. As illustrated in FIG. 1, the computing system 100 may include a host processor 110 (e.g., x86 CPU, ARM, RISC-V), an electronic device 130, and a nonvolatile memory 140. The host processor 110 may be connected to a host memory 120. The electronic device 130 may include a volatile memory 132.

The computing system 100 according to the present disclosure may have a scalable device structure that may use the volatile memory 132 of the electronic device 130 as an intermediate storage medium and use the nonvolatile memory 140 as a final storage medium. The host processor 110 may recognize the entire capacity of the nonvolatile memory 140 connected to the electronic device 130.

The host processor 110 may communicate with the electronic device 130 using a first interface 150. The first interface 150 may be a serial interface, and for example, may be an interface using a PCIe or CXL (compute express link) protocol. The electronic device 130 may communicate with the nonvolatile memory 140 using a second interface 160. The second interface 160 may be a serial interface.

In the computing system 100 according to the present disclosure, the first interface 150 may be a byte-addressable protocol (or byte-addressing protocol), and the second interface 160 may be a block-addressable protocol (or block-addressing protocol). The host processor 110 may read and write data by addressing the electronic device 130 in byte units. The electronic device 130 may read and write data by addressing the nonvolatile memory 140 in block units. The electronic device 130 may fetch data in block units from the nonvolatile memory 140 based on a byte address and store the data in the volatile memory 132 of the electronic device 130. The electronic device 130 may access data corresponding to an address requested by the host processor 110 among the data stored in the volatile memory 132.

According to an embodiment, the electronic device 130 may internally have a cache for data stored in the volatile memory 132 to improve performance.

In FIG. 1, for convenience of explanation, it is illustrated that the nonvolatile memory 140 is configured separately from the electronic device 130. However, the present disclosure is not limited thereto. For example, in the present disclosure, the nonvolatile memory 140 may be integrated and configured together with the electronic device 130.

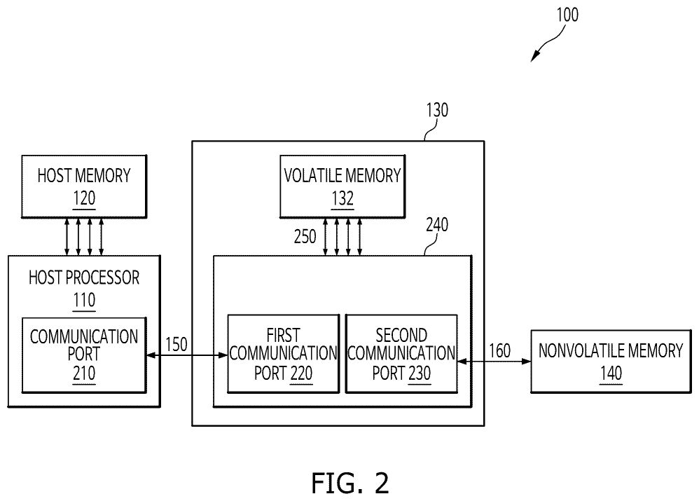

FIG. 2 is a block diagram of a computing system 100 including an electronic device 130 according to an embodiment of the present disclosure.

As illustrated in FIG. 2, the computing system 100 includes a host processor 110, an electronic device 130, and a nonvolatile memory 140. The host processor 110 may include a communication port 210. The electronic device 130 may include a volatile memory 132 and a controller 240.

The host processor 110 may mean a set of one or more processors. The host processor 110 may drive software (e.g., commands, programs, etc.) to control at least one component of a device or terminal (e.g., electronic device 130) connected to the host processor 110. In addition, the host processor 110 may perform various operations such as various computations, processing, data generation, or processing. In addition, the host processor 110 may load data from various volatile or nonvolatile memories or storages or store the data in volatile or nonvolatile memories or storages.

The controller 240 may have one or more volatile memory channels and may communicate with individual components or the volatile memory 132 through these volatile memory channels. The volatile memory 132 may be, for example, a DIMM type DRAM. The controller 240 may include a first communication port 220. For example, the first communication port 220 may be a PCIe end point or a CXL End Point. According to an embodiment, the controller 240 may further include a second communication port 230. For example, the second communication port 230 may be a PCIe Root Complex port. According to an embodiment, the first communication port 220 and the second communication port 230 may be communication interfaces having a plurality of channels (e.g., 8 channels, 16 channels, etc.).

The controller 240 may communicate with the host processor 110 via the first interface 150 through the first communication port 220 and the communication port 210. In addition, the controller 240 may communicate with the volatile memory 132 via a third interface 250. In addition, the controller 240 may communicate with the nonvolatile memory 140 via the second interface 160 through the second communication port 230. Here, the first interface 150 and the second interface 160 may be serial interfaces, and the third interface 250 may be a parallel interface.

The controller 240 may communicate with the host processor 110 using a first protocol. In addition, the controller 240 may communicate with the volatile memory 132 using a second protocol. In addition, the controller 240 may communicate with the nonvolatile memory 140 using a third protocol. Here, the first protocol and the second protocol may be byte-addressable protocols that can read and write data by addressing in byte units, and the third protocol may be a block-addressable protocol that can read and write data by addressing in block units.

The nonvolatile memory 140 may include one or more nonvolatile memories. According to an embodiment, as many nonvolatile memories as the interface allows may be directly connected to the second communication port 230. Here, the nonvolatile memory may include a hard disk drive (HDD), a solid state drive (SSD), etc.

The controller 240 according to the present disclosure may receive a swap-out request or command for page-unit data (hereinafter, referred to as ‘page data’) from the host processor 110. According to an embodiment, a host operating system (OS) may determine the page data to be swapped out. For example, the host operating system may determine to swap out page data stored in the host memory 120 that has not been accessed for a predetermined period or has a low access frequency. The host processor 110 may transmit a swap-out request including page information to the controller 240 through the communication port 210 and the first communication port 220. For example, the page information may include a process ID and address for each program.

The controller 240 may determine the availability of the volatile memory 132 in response to the swap-out request. If it is determined that the volatile memory 132 is not available, the controller 240 may transmit an error message (e.g., memory full error) to the host processor 110. If it is determined that the volatile memory 132 is available, the controller 240 may receive the page data from the host processor 110, compress the page data, and store the compressed page data in the volatile memory 132.

The controller 240 according to the present disclosure may manage the volatile memory 132 by dividing the volatile memory 132 into a compressed memory pool and a temporary memory pool. For example, the controller 240 may define and manage a first area of the volatile memory 132 as a compressed memory pool, and define and manage a second area different from the first area as a temporary memory pool. The controller 240 may decide to store specific data in the compressed memory pool or the temporary memory pool depending on whether the data is compressed when storing the specific data in the volatile memory 132.

According to an embodiment, the controller 240 may store the swap-out requested page data in a first temporary buffer within the temporary memory pool. For example, the size of the first temporary buffer may be allocated to be the same as the page data (e.g., 4 KB). The controller 240 may store the swap-out requested page data in the first temporary buffer within the temporary memory pool. The controller 240 may compress the page data stored in the first temporary buffer and store the compressed page data in a second temporary buffer within the temporary memory pool. For example, the size of the second temporary buffer may be allocated to be the same as the size of the first temporary buffer (e.g., 4 KB). The controller 240 may store the compressed data stored in the second temporary buffer in a storage area within the compressed memory pool. The size of the storage area may correspond to the size of the compressed data. For example, the size of the storage area may be the same as, correspond to, or be proportional to the size of the compressed data. The controller 240 may record the location of the storage area in the metadata of the swap-out requested page data. In addition, the controller 240 may notify the host processor 110 of the completion of processing the swap-out request.

In general, even if data of the same size is compressed, the size of the compressed data generated as a result of compression may vary. According to the controller 240 of the present disclosure, after compressing the page data in the temporary memory pool and identifying the size of the compressed data, the compressed data may be stored by allocating an amount corresponding to the size of the compressed data in the compressed memory pool. With this configuration, effective management of the compressed memory pool is possible, and the availability of the compressed memory pool may be increased.

The controller 240 according to the present disclosure may receive a swap-in request or command for page-unit data from the host processor 110. According to an embodiment, the host operating system may determine the page data to be swapped in and the location where the page data will be stored in the host memory 120. The host processor 110 may transmit a swap-in request including page information and location information on the host memory 120 to the controller 240 through the communication port 210 and the first communication port 220. For example, the page information may include a process ID and address for each program.

The controller 240 may search for the compressed data in which the page data is compressed in response to the swap-in request. According to an embodiment, the controller 240 may identify the location of the compressed data within the volatile memory 132 based on the page information and the metadata of the page data. The compressed data may be located in the compressed memory pool of the volatile memory 132. According to an embodiment, the controller 240 may decompress the compressed data and store the decompressed data in a temporary buffer within the temporary memory pool. For example, the size of the temporary buffer may be allocated to be the same as the page data (e.g., 4 KB).

The controller 240 may transmit the decompressed data to the host processor 110. For example, the controller 240 may transmit the decompressed data to the location information on the host memory 120 included in the swap-in request. The controller 240 may notify the host processor 110 of the completion of processing the swap-in request. In addition, the controller 240 may initialize the information of the metadata of the swap-in requested page data.

According to the computing system 100 of the present disclosure, since the host processor 110 does not need to directly perform compression operations or manage compressed data, the overall system availability may be improved. In addition, the electronic device 130 according to the present disclosure provides offloading for compression functions and data transfer while expanding the capacity of the host memory 120, so the overall system performance may be improved.

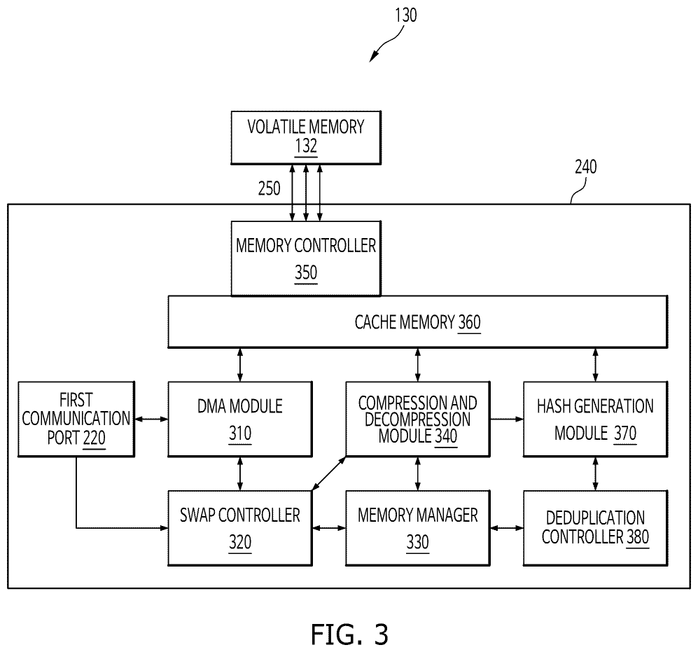

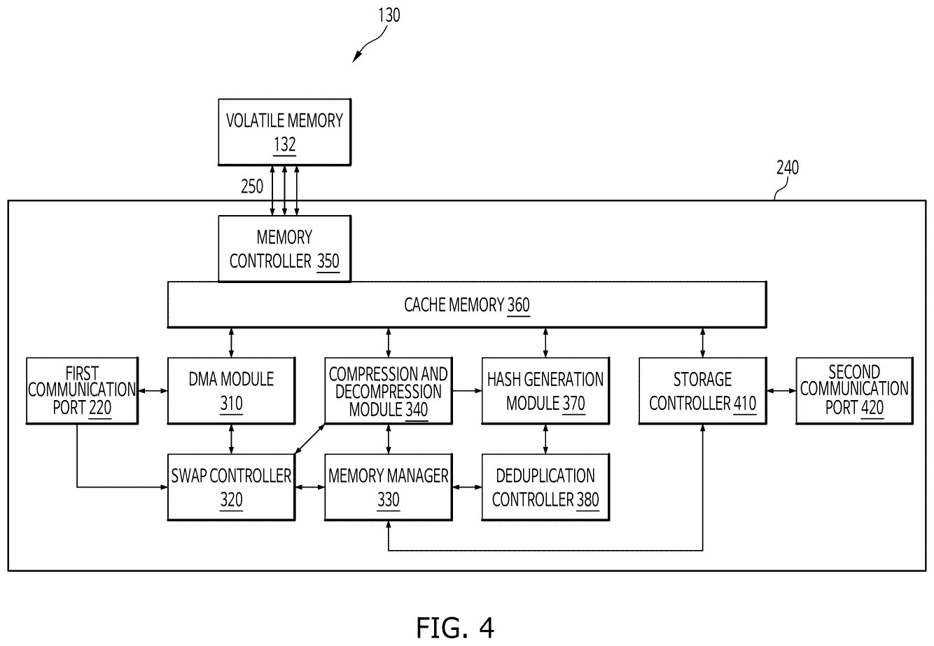

FIG. 3 is a block diagram of a controller 240 included in an electronic device 130 according to an embodiment of the present disclosure. FIG. 4 is a block diagram of a controller 240 included in an electronic device 130 according to another embodiment of the present disclosure.

As illustrated in FIGS. 3 and 4, the controller 240 may include a Swap Controller 320 (which may also be referred to as a ‘Zswap Controller’), a Memory Manager 330, and a Compression and Decompression Module 340. In addition, the controller 240 may further include a first communication port 220, a Direct Memory Access (DMA) module 310, a memory controller 350, a cache memory 360, a hash generation module 370, and a deduplication controller. In FIG. 4, the controller 240 may further include a storage controller 410 and a second communication port 420.

To process a swap-out request from the host processor 120, the swap controller 320 may request allocation of a memory space in the volatile memory 132 based on page information for the page data included in the swap-out request and control the compression of the page data. The memory manager 330 may secure an empty space in the volatile memory 132 according to the decision of the swap controller 320. The memory manager 330 may manage the volatile memory 132 by dividing the volatile memory 132 into a compressed memory pool and a temporary memory pool. The compression and decompression module 340 (or a compressor included in the compression and decompression module 340) may compress the page data according to the decision of the swap controller 320.

To process a swap-in request from the host processor 120, the swap controller 320 may identify the storage location of the compressed data of the corresponding page data within the volatile memory 132 based on the page information for the page data included in the swap-in request and the metadata of the page data. The swap controller 320 may control the decompression of the compressed data. The memory manager 330 may secure an empty space in the volatile memory 132 according to the decision of the swap controller 320. The compression and decompression module 340 (or a decompressor included in the compression and decompression module 340) may decompress the compressed data according to the decision of the swap controller 320.

The DMA module 310 may receive data being swapped out from the host processor 120 or transmit data being swapped in using a predetermined protocol. In addition, the cache memory 360 may be configured to store data that has been accessed or is expected to be accessed. The memory controller 350 may be connected to the volatile memory 132 and the cache memory 360. The memory controller 350 may be configured to be able to read or write data by accessing the volatile memory 132.

The hash generation module 370 may generate a hash value associated with page data included in a swap-out request and/or a hash value associated with compressed data in response to the swap-out request from the host processor 120. The hash generation module 370 may directly receive the swap-out request from the host processor 120 through the first communication port 220. Alternatively, the hash generation module 370 may indirectly receive the swap-out request from the host processor 120 through the swap controller 320.

The hash generation module 370 may generate a hash value associated with the page data included in the swap-out request and/or a hash value associated with the compressed data based on a hash algorithm. According to an embodiment, the hash generation module 370 may generate a hash value associated with uncompressed data. According to another embodiment, the hash generation module 370 may generate a hash value associated with compressed data. As the hash algorithm, CRC, MD5, SHA, etc. may be used. The hash generation module 370 may transmit the generated hash value to the deduplication controller 380 to be stored in a deduplication table, and the generated hash value may be used for deduplication of the compressed data stored in the volatile memory 132. According to an embodiment, the deduplication table may be stored in the volatile memory 132.

The deduplication controller 380 may manage the deduplication table based on information received from the hash generation module 370 and/or the swap controller 320. According to an embodiment, the deduplication controller 380 may generate the deduplication table based on the hash value received from the hash generation module 370 and the metadata of the page data received from the swap controller 320. The deduplication controller 380 may record information of the page data and/or information of the compressed data stored in the volatile memory 132 in the deduplication table. In this case, the metadata of the page data may include a page address value, data size, etc. of the page data and/or compressed data.

The deduplication controller 380 may identify corresponding compressed data based on the deduplication table. According to an embodiment, the deduplication controller 380 determines whether a first hash value and a second hash value included in the deduplication table are identical, and in response to determining that the first hash value and the second hash value are identical, may determine whether first compressed data (or first page data) associated with the first hash value and second compressed data (or second page data) associated with the second hash value are identical. In response to determining that the first compressed data (or the first page data) and the second compressed data (or the second page data) are identical, the deduplication controller 380 may transmit information of the compressed data (or page data) to the swap controller 320.

The swap controller 320 may determine which data to delete between the first compressed data and the second compressed data based on the information transmitted from the deduplication controller 380. For example, the swap controller 320 may compare a counter value of the first compressed data and a counter value of the second compressed data included in the deduplication table from the deduplication controller 380, and may determine the compressed data with the smaller counter value as the data to be deleted. In this case, the counter value may be the number of page data referencing the page address value.

Subsequently, the swap controller 320 may increment the counter value associated with the compressed data that is not deleted. For example, if it is decided to delete the second compressed data, the swap controller 320 may increment the counter value of the first compressed data included in the deduplication table. Alternatively, the swap controller 320 may transmit a command to the deduplication controller 380 to increment the counter value of the first compressed data.

Subsequently, the swap controller 320 may change the metadata of the page data that references the compressed data decided to be deleted, and delete the compressed data decided to be deleted and the information of the compressed data. For example, if it is decided to delete the second compressed data, the swap controller 320 may increment the counter value of the first compressed data, and change the metadata of the second page data that references the address value of the second compressed data to reference the address value of the first compressed data. In addition, the swap controller 320 may delete the second compressed data stored in the volatile memory 132, and delete the information of the second compressed data recorded in the deduplication table. Alternatively, the swap controller 320 may transmit a command to process the above-described process to the deduplication controller 380.

The DMA module 310, the swap controller 320, the memory manager 330, the compression and decompression module 340, the memory controller 350, the hash generation module 370, and the deduplication controller 380 illustrated in FIG. 3 may each be implemented as a hardware device or software code. According to an embodiment, the DMA module is implemented as a hardware device, and the other components may be implemented as software code. According to an embodiment, the compression and decompression module 340 may be implemented as a mixture of a hardware device and software code. For example, a decompressor of the compression and decompression module 340 may be implemented in hardware, and a compressor may be implemented in software. In addition, FIG. 3 illustratively shows the configurations of the controller 240, and the present disclosure is not limited thereto. For example, some of the configurations illustrated in FIG. 3 may be omitted, or the function of a specific configuration may be implemented to be included in another configuration.

As illustrated in FIG. 4, the controller 240 may further include a storage controller (or nonvolatile memory controller) 410. The storage controller 410 may be configured to drive the nonvolatile memory 140 through the second communication port 420 to perform data reading or writing by addressing in block units.

The controller 240 may determine cold data among the data stored in the compressed memory pool within the volatile memory 132. According to an embodiment, the memory manager 330 may determine cold data in the currently allocated compressed memory pool based on information such as memory allocation time information and page access frequency. The cold data may mean data stored in the compressed memory pool that is not frequently accessed and can be swapped out to another device.

The controller 240 may transmit the cold data to the nonvolatile memory 140. The storage controller 410 may swap out the cold data to the nonvolatile memory 140. According to an embodiment, the cold data existing in the compressed memory pool may be swapped out in a compressed state. In this case, the storage controller 410 may transmit the cold data existing in the compressed memory pool in a compressed state to the nonvolatile memory 140 through the second communication port 420.

According to another embodiment, the cold data existing in the compressed memory pool may be decompressed and then swapped out. In this case, the swap controller 320 may request the memory manager 330 to allocate a temporary buffer in the temporary memory pool. The compression and decompression module 340 may decompress the cold data to generate decompressed data according to the request of the swap controller 320, and may store the decompressed data in the temporary buffer. The storage controller 410 may transmit the decompressed data stored in the temporary buffer to the nonvolatile memory 140.

According to the embodiment of transmitting decompressed data, compared to the embodiment of transmitting compressed data, delay may be reduced when access to the corresponding data is needed again later.

Subsequently, the controller 240 may receive a request (swap-in request) for page data that has been swapped out to the nonvolatile memory 140 from the host processor 110. In response to the request, the swap controller 320 may request the memory manager 330 to allocate a temporary buffer in the temporary memory pool. The storage controller 410 may fetch the page data to the temporary buffer from the nonvolatile memory 140. The swap controller 320 may transmit the page data stored in the temporary buffer to the host processor 110 through the DMA module 310. If the data fetched to the temporary buffer is compressed data, the controller 240 may decompress the compressed data using the compression and decompression module 340 and then transmit the decompressed data to the host processor 110 through the DMA module 310.

According to the present disclosure, it is possible to selectively swap out data that has little need to be maintained for performance in the volatile memory 132 to the nonvolatile memory 140. According to the present disclosure, by performing a primary swap-out from the host memory 120 to the volatile memory 132, and a secondary swap-out from the volatile memory 132 to the nonvolatile memory 140, the overall memory efficiency may be improved. According to the present disclosure, since the electronic device 130 processes the swap-out from the volatile memory 132 to the nonvolatile memory 140, the management burden of the host operating system may be reduced and the performance of the entire computing system 100 may be improved.

The controller 240 may perform deduplication on the data stored in the volatile memory 132 and the data stored in the nonvolatile memory 140 based on the deduplication table. According to an embodiment, the deduplication controller 380 determines whether third compressed data stored in the volatile memory 132 and fourth compressed data stored in the nonvolatile memory 140 are identical, and in response to determining that the third compressed data and the fourth compressed data are identical, may set a candidate flag of the third compressed data included in the deduplication table. Subsequently, the deduplication controller 380 may transmit information of the third compressed data including the candidate flag to the swap controller 320.

According to an embodiment, the swap controller 320 determines whether a predetermined time has elapsed, and in response to determining that the predetermined period has elapsed, may delete the third compressed data from the volatile memory 132, delete information about the third compressed data included in the deduplication table, and change metadata associated with the third compressed data. For example, the swap controller 320 may change the metadata so that third page data corresponding to the third compressed data references a page address value of the fourth compressed data.

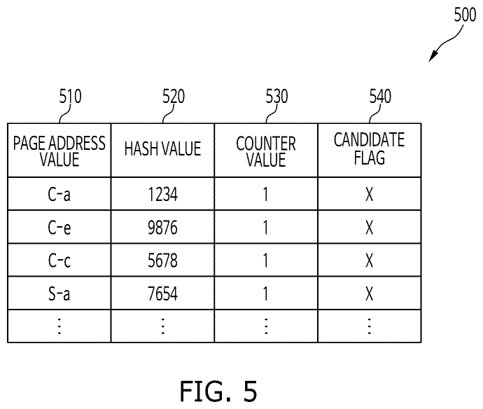

FIG. 5 is a diagram for explaining a deduplication table 500 according to an embodiment of the present disclosure. The deduplication table 500 may include information associated with compressed data stored in a volatile memory. According to an embodiment, the deduplication table 500 may include a plurality of entries. Each of the plurality of entries may be information of each compressed data. An entry for compressed data may include a page address value 510, a hash value 520, a counter value 530, and a candidate flag 540 of the corresponding compressed data, and the page address value 510 may include a memory address of the volatile memory (e.g., volatile memory 132 of FIGS. 2-4, etc.) where the compressed data is stored and/or a memory address of the nonvolatile memory (e.g., nonvolatile memory 140 of FIGS. 2-4, etc.). According to an embodiment, the page address value of the compressed data stored in the volatile memory may start with ‘C’ (e.g., C-a, C-e, C-c, etc.). In addition, the page address value of the compressed data stored in the nonvolatile memory may start with ‘S’ (e.g., S-a, etc.).

The hash value 520 may be a hash value generated for compressed data (or page data corresponding to the compressed data). According to an embodiment, the hash value 520 may be generated based on a hash algorithm (e.g., CRC, MD5, SHA, etc.), and may be used to determine whether the compressed data (or the page data corresponding to the compressed data) is identical.

The counter value 530 may be the number of page data referencing the page address value. For example, if first page data that has been swapped out is referencing the page address value ‘C-a’ of first compressed data, the counter value of the first compressed data may be ‘l’. As another example, if first page data and second page data that have been swapped out are referencing the page address value ‘C-a’ of first compressed data, the counter value of the first compressed data may be ‘2’.

The candidate flag 540 may indicate whether compressed data stored in a volatile memory and compressed data stored in a nonvolatile memory are identical. For example, if second compressed data stored in the volatile memory and third compressed data stored in the nonvolatile memory are identical, a candidate flag of the second compressed data and/or the third compressed data may be set (i.e., the candidate flag may be ‘O’). Alternatively, if a hash value of the second compressed data and a hash value of the third compressed data are identical, a candidate flag of the second compressed data and/or the third compressed data may be set (i.e., the candidate flag may be ‘O’). On the other hand, if data identical to the compressed data stored in the volatile memory (or the compressed data stored in the nonvolatile memory) is not stored in the nonvolatile memory (or the volatile memory), the candidate flag of the compressed data may be cleared (i.e., the candidate flag may be ‘X’).

The fields and/or entries of the deduplication table 500 illustrated in FIG. 5 are only an example, and may be implemented differently in some embodiments. For example, field names or data may be different, some fields and/or entries may be omitted, or new fields and/or entries may be added.

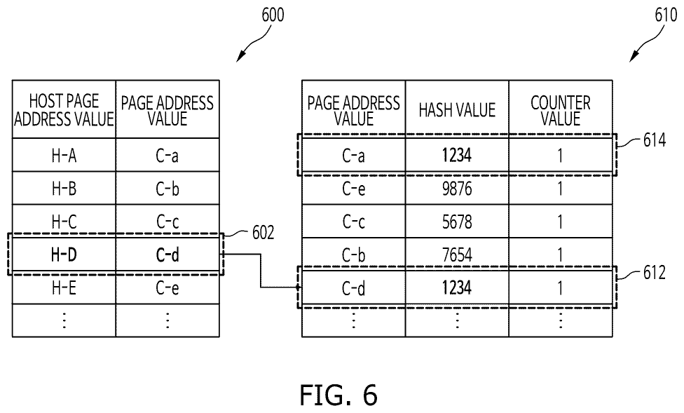

FIG. 6 is a diagram for explaining an operation in which a controller processes a swap-out request according to an embodiment of the present disclosure. A controller (e.g., controller 240 of FIGS. 2-4, etc.) may receive a swap-out request from a host processor, and may manage a metadata table 600 of page data and a deduplication table 610 of compressed data based on the received swap-out request. In addition, the controller may identify corresponding compressed data among a plurality of compressed data based on the deduplication table 610, and may determine whether to perform data deduplication. In FIG. 6, the metadata table 600 and the deduplication table 610 are illustrated as separate tables, but are not limited thereto, and each of the tables 600, 610 may be part of a single merged table.

According to an embodiment, a swap controller of the controller (e.g., swap controller 320 of FIGS. 3 and 4, etc.) may receive a swap-out request from a host processor. Subsequently, the swap controller may cause a compression and decompression module to generate compressed data from page data included in the swap-out request. In addition, the swap controller may record a host page address value, which is a memory address of a host memory allocated to the corresponding page data, and a page address value, which is a memory address of a volatile memory where the compressed data is stored, in the metadata table 600. For example, if the host page address value of the page data included in the swap-out request is ‘H-D’ and the page address value where the compressed data of the corresponding page data is stored is ‘C-d’, the swap controller may record the page address value as ‘C-d’ in a fourth entry 602 of the metadata table 600 corresponding to the host page address value ‘H-D’.

According to an embodiment, the swap controller may cause a hash generation module (e.g., hash generation module 370 of FIGS. 3 and 4, etc.) and a deduplication controller (e.g., deduplication controller 380 of FIGS. 3 and 4, etc.) to record information associated with the compressed data of the corresponding page data in a deduplication table 610. For example, the hash generation module may generate a hash value for the corresponding compressed data as ‘1234’ and may transmit the generated hash value to the deduplication controller. The deduplication controller may record the hash value for the corresponding compressed data transmitted from the hash generation module, the page address value for the corresponding compressed data, and the counter value for the corresponding compressed data in a fifth entry 612 of the deduplication table 610.

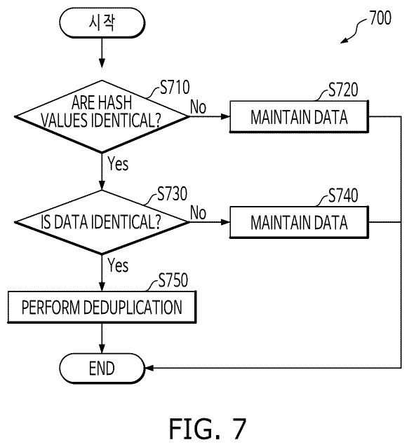

According to an embodiment, the deduplication controller may identify corresponding compressed data among a plurality of compressed data based on the deduplication table, and may transmit information of the identified compressed data to the swap controller. For example, the deduplication controller may determine that the hash values recorded in a first entry 614 and the fifth entry 612 of the deduplication table are identical as ‘1234’, and may transmit information recorded in the first entry 614 (e.g., page address value, hash value, counter value, etc.) and information recorded in the fifth entry 612 (e.g., page address value, hash value, counter value, etc.) to the swap controller. The swap controller may determine whether to perform data deduplication based on the transmitted information. Detailed content on this will be described later with reference to FIG. 7.

Generating a hash value for compressed data and/or a hash value for page data and identifying the compressed data may be performed independently. For example, a hash value for the compressed data and/or a hash value for the page data may be generated at a first period, and corresponding compressed data among the plurality of compressed data may be identified at a second period different from the first period.

FIG. 7 is a flowchart 700 regarding an operation in which a controller determines whether to perform data deduplication according to an embodiment of the present disclosure. In an embodiment, the operation of determining whether to perform data deduplication may be performed by a controller (e.g., controller 240 of FIGS. 2-4, etc.) or a swap controller of the controller (e.g., swap controller of FIGS. 3 and 4, etc.).

The operation of determining whether to perform data deduplication may be initiated by determining whether hash values are identical S710. In an embodiment, the controller (or swap controller) may determine whether a first hash value of first compressed data and a second hash value of second compressed data included in a deduplication table are identical. If the first hash value and the second hash value are different, the controller (or swap controller) may determine that the first compressed data and the second compressed data are different, and may maintain the data without deleting the data S720.

On the other hand, when it is determined that the first hash value and the second hash value are identical, the controller (or swap controller) may determine whether the first compressed data and the second compressed data are identical S730. For example, the controller (or swap controller) may compare bits of the first compressed data and bits of the second compressed data to determine whether the first compressed data and the second compressed data are identical. If the first compressed data and the second compressed data are different, the controller (or swap controller) may maintain the first compressed data and the second compressed data without deleting the first compressed data and the second compressed data.

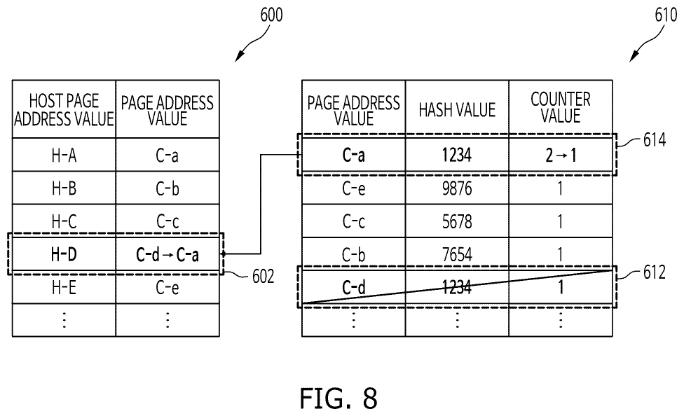

On the other hand, when it is determined that the first compressed data and the second compressed data are identical, the controller (or swap controller) may perform data deduplication S750. Detailed content on this will be described later with reference to FIG. 8.

The flowchart 700 illustrated in FIG. 7 and the above description are only an example, and may be implemented differently in some embodiments. For example, in some embodiments, the order of each step may be changed, some steps may be performed repeatedly, some steps may be omitted, or some steps may be added.

FIG. 8 is a diagram for explaining an operation in which a controller performs data deduplication according to an embodiment of the present disclosure. A controller (e.g., controller 240 of FIGS. 2-4, etc.), in response to determining that a plurality of compressed data are identical to each other, may change metadata of page data included in a metadata table 600, delete and change information of compressed data included in a deduplication table 610, and delete at least some of the plurality of compressed data. In FIG. 8, the metadata table 600 and the deduplication table 610 are illustrated as separate tables, but are not limited thereto, and each of the tables 600, 610 may be part of a single merged table.

According to an embodiment, a swap controller of the controller (e.g., swap controller 320 of FIGS. 3 and 4, etc.) determines that first compressed data corresponding to a first entry 614 of the deduplication table and second compressed data corresponding to a fifth entry 612 are identical to each other, and may determine one of the first compressed data and the second compressed data as a deletion target. For example, the swap controller may determine the later stored second compressed data as the deletion target. As another example, the swap controller may determine the compressed data with a lower counter value as the deletion target.

According to an embodiment, before or after deleting the second compressed data, the swap controller may increment the counter value of the first compressed data that is not the deletion target. For example, the swap controller may change the counter value of the first entry of the deduplication table 610 from ‘l’ to ‘2’. Alternatively, the swap controller may cause a deduplication controller (e.g., deduplication controller 380 of FIGS. 3 and 4, etc.) to increment the counter value of the first compressed data. Through this, a problem where a swap-in request occurs during data deletion and the deletion target becomes the return target compressed data may be prevented.

According to an embodiment, the swap controller may change the metadata of the page data corresponding to the deleted compressed data. For example, the swap controller may change the page address value of a fourth entry 602 of the metadata table 600 from ‘C-d’, which is the page address value of the deleted compressed data, to ‘C-a’, which is the page address value of the identical compressed data that was not deleted.

According to an embodiment, the swap controller may delete the second compressed data that is the deletion target, and may delete a fifth entry 612 of the deduplication table 610. Alternatively, the swap controller may transmit a request to delete the fifth entry 612 of the deduplication table 610 to the deduplication controller, and the deduplication controller may delete the fifth entry 612.

Through the above-described configuration, one of a plurality of corresponding compressed data stored in a volatile memory may be deleted based on a deduplication table. Accordingly, a duplicate storage problem where the same data is stored duplicately may be prevented, and memory and input/output resources may be used efficiently.

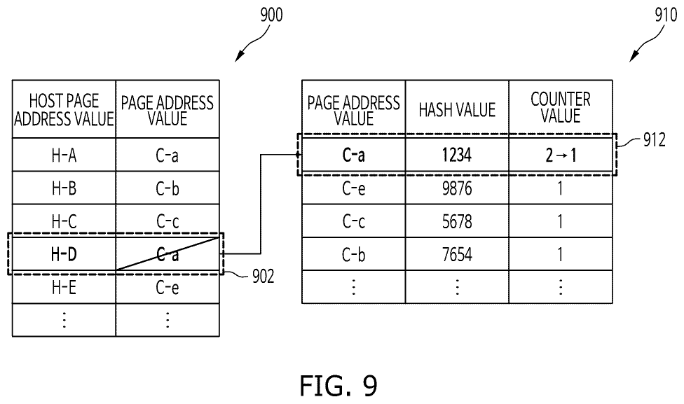

FIG. 9 is a diagram for explaining an operation in which a controller processes a swap-in request according to an embodiment of the present disclosure. A controller (e.g., controller 240 of FIGS. 2-4, etc.) receives a swap-in request for compressed data stored in a volatile memory from a host processor, and in response to the swap-in request, transmits page data generated by decompressing the compressed data to the host processor, and may manage a metadata table 900 and a deduplication table 910. In FIG. 9, the metadata table 900 and the deduplication table 910 are illustrated as separate tables, but are not limited thereto, and each of the tables 900, 910 may be part of a single merged table.

According to an embodiment, a swap controller of the controller (e.g., swap controller 320 of FIGS. 3 and 4, etc.) may delete the page address value of the page data that is the target of the swap-in request. For example, metadata of the page data that is the target of the swap-in request may be stored in a fourth entry 902 of the metadata table 900, and the swap controller may delete the page address value of the fourth entry 902.

According to an embodiment, the swap controller may change the counter value for the compressed data that is the target of the swap-in request. For example, information of the compressed data that is the target of the swap-in request may be stored in a first entry 912 of a deduplication table 910, and the swap controller may change the counter value of the first entry 912 from ‘2’ to ‘l’. Alternatively, the swap controller may cause a deduplication controller (e.g., deduplication controller 380 of FIGS. 3 and 4, etc.) to change the counter value for the compressed data that is the target of the swap-in request.

According to an embodiment, the swap controller may delete compressed data with a counter value of ‘0’ or less. Along with this, the swap controller may delete the entry of the compressed data with a counter value of ‘0’ or less from the deduplication table. Alternatively, the swap controller may cause the deduplication controller to delete the entry of the compressed data with a counter value of ‘0’ or less from the deduplication table.

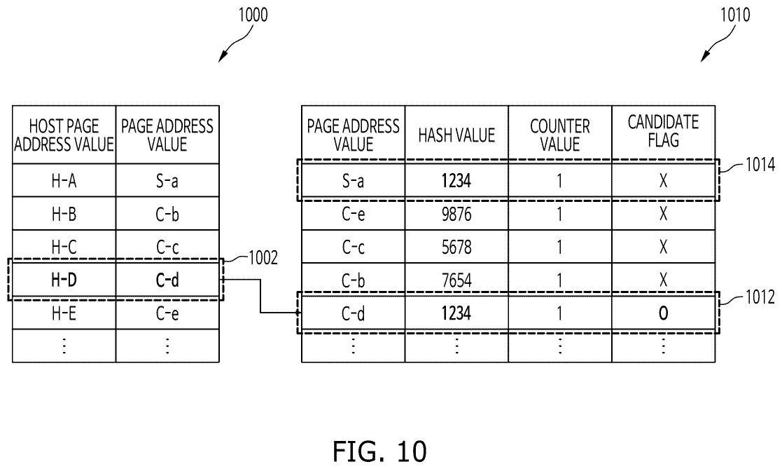

FIG. 10 is a diagram for explaining an operation in which a controller sets a candidate flag according to an embodiment of the present disclosure. A controller (e.g., controller 240 of FIGS. 2-4, etc.) may receive a swap-out request from a host processor, and may manage a metadata table 1000 of page data and a deduplication table 1010 of compressed data based on the received swap-out request. For example, a swap controller of the controller (e.g., swap controller 320 of FIGS. 3 and 4, etc.) may record metadata of the page data included in the swap-out request in a fourth entry 1002 of the metadata table 1000. In FIG. 10, the metadata table 1000 and the deduplication table 1010 are illustrated as separate tables, but are not limited thereto, and each of the tables 1000, 1010 may be part of a single merged table.

The controller may determine whether compressed data stored in a volatile memory is identical to compressed data stored in a nonvolatile memory based on a deduplication table 1010. According to an embodiment, a deduplication controller of the controller (e.g., deduplication controller 380 of FIGS. 3 and 4, etc.) may identify compressed data with the same hash value included in the deduplication table 1010, and may determine whether the identified compressed data is identical. For example, the deduplication controller may identify that a hash value of a first entry 1014 and a hash value of a fifth entry 1012 of the deduplication table 1010 are identical as ‘1234’, and may identify whether the compressed data corresponding to the first entry 1014 and the compressed data corresponding to the fifth entry 1012 are identical to each other. Alternatively, the deduplication controller may identify compressed data with the same hash value included in the deduplication table 1010, and may not determine whether the identified compressed data is identical.

The controller, in response to determining whether the compressed data stored in the volatile memory is identical to the compressed data stored in the nonvolatile memory, may set a candidate flag of the compressed data included in the deduplication table 1010. According to an embodiment, the deduplication controller determines the compressed data corresponding to the first entry 1014 and the compressed data corresponding to the fifth entry 1012 as identical compressed data, and may set the candidate flag of the fifth entry 1012. In this case, the compressed data for which the candidate flag is set may be the compressed data stored in the volatile memory.

Alternatively, the deduplication controller determines that the hash values of the compressed data corresponding to the first entry 1014 and the compressed data corresponding to the fifth entry 1012 are identical, and may set the candidate flag of the compressed data corresponding to the fifth entry 1012. Similarly, the compressed data for which the candidate flag is set may be the compressed data stored in the volatile memory.

Managing the metadata table 1000 and the deduplication table 1010 of the compressed data based on a swap-out request and setting a candidate flag for the compressed data may be performed independently. For example, the metadata table 1000 of the page data and the deduplication table 1010 of the compressed data may be managed at a third period based on the swap-out request, and the candidate flag of the compressed data may be set at a fourth period different from the third period.

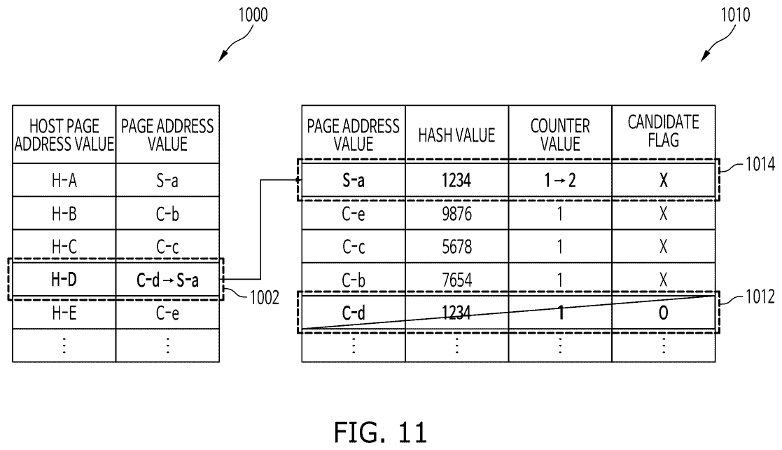

FIG. 11 is a diagram for explaining an operation in which a controller performs data deduplication on compressed data for which a candidate flag is set, according to an embodiment of the present disclosure. A controller (e.g., controller 240 of FIGS. 2-4, etc.) may determine whether a predetermined time has elapsed after a candidate flag is set. According to an embodiment, a reference time may be set based on a reception cycle of a swap-out request and a swap-in request, and the controller may determine whether the reference time has elapsed after the candidate flag is set.

The controller, in response to determining that a predetermined time has elapsed, may change a counter value for the compressed data. According to an embodiment, although a deduplication table 1010 has been determined to be the same compressed data, the deduplication table 1010 may include information about compressed data for which a candidate flag is not set in a first entry 1014, and a deduplication controller (e.g., deduplication controller 380 of FIGS. 3 and 4, etc.) or a swap controller (e.g., swap controller 320 of FIGS. 3 and 4, etc.) of the controller may change the counter value of the first entry 1014.

In addition, the controller, in response to determining that a predetermined time has elapsed, may change metadata of the compressed data. According to an embodiment, a metadata table 1000 may include metadata for the compressed data for which a candidate flag is set (i.e., the candidate flag is ‘O’) in a fourth entry 1002. The swap controller may change the page address value of the fourth entry 1002 to the page address value of the compressed data that was determined to be the same compressed data but for which the candidate flag was not set.

In addition, the controller, in response to determining that a predetermined time has elapsed, may delete the compressed data for which the candidate flag is set and the information of the compressed data. According to an embodiment, a candidate flag may be preferentially set for compressed data stored in a volatile memory. The swap controller, in response to determining that a predetermined time has elapsed, may delete the compressed data for which the candidate flag is set from the volatile memory. Along with this, the swap controller or the deduplication controller may delete a fifth entry 1012 including information of the compressed data for which the candidate flag is set from a deduplication table 1010.

Through the above-described configuration, a candidate flag may be set in response to determining that data stored in a nonvolatile memory and data stored in a volatile memory are identical, and the data for which the candidate flag is set may be deleted after a predetermined time has passed. Accordingly, a swap-in request for duplicately stored data may be processed promptly, and at the same time, the volatile memory and the nonvolatile memory may be managed efficiently.

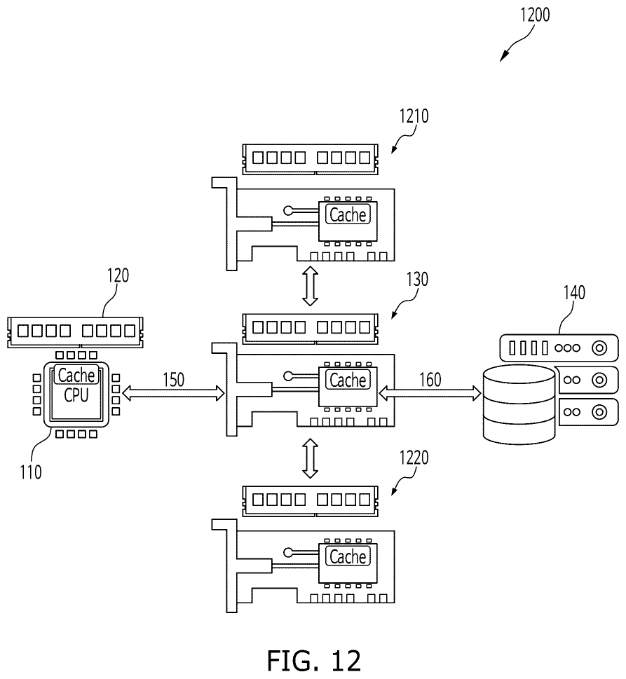

FIG. 12 is a conceptual exemplary diagram illustrating a computing system 1200 including an electronic device according to another embodiment of the present disclosure. A computing system 1000 according to this embodiment may include a plurality of electronic devices 130, 1210, 1200. Some components of the embodiment according to FIG. 12 may be the same as or similar to some components of the embodiment according to FIG. 1, and detailed descriptions of the same or corresponding components will be omitted.

The electronic device 130 according to the present disclosure may be connected to external electronic devices 1210, 1220. The controller 240 of the electronic device 130 may receive a swap-out request for page-unit data not only from the host processor 110 but also from the external electronic devices 1210, 1220. For example, the controller 240, in response to a swap-out request from the external electronic device 1210, may receive the corresponding page data and compress the page data to generate compressed data. The controller 240 may store the generated compressed data in the volatile memory 132.

The controller 240 of the electronic device 130 may receive a swap-in request for page-unit data not only from the host processor 110 but also from the external electronic devices 1210, 1220. For example, the controller 240, in response to a swap-in request from the external electronic device 1210, may decompress the compressed data in which the corresponding page data is compressed to generate decompressed data. The controller 240 may transmit the generated decompressed data to the external electronic device 1210.

According to the present disclosure, swap-out and swap-in requests from not only the host processor 110 but also other electronic devices 1210, 1220 may be processed. When the electronic device 130 is configured to be connectable to a plurality of other electronic devices 1210, 1220, management considering the memory availability of each electronic device is possible. Accordingly, the performance of the entire computing system 1000 may be improved.

The methods according to the present disclosure may be computer-implemented methods. In the present disclosure, although each step of the methods is illustrated and described in a predetermined order, each step may be performed in an order that can be arbitrarily combined according to the present disclosure, in addition to being performed sequentially. In an embodiment, at least some of the steps may be performed in parallel, repeatedly, or heuristically. The present disclosure does not exclude making changes or modifications to the methods. In an embodiment, at least some of the steps may be omitted, or other steps may be added.

The various embodiments of the present disclosure may be implemented as software recorded on a machine-readable recording medium. The software may be software for implementing the various embodiments of the present disclosure described above. The software may be inferred from the various embodiments of the present disclosure by programmers in the technical field to which the present disclosure pertains. For example, the software may be a machine-readable instruction (e.g., code or code segment) or program. A machine may be a device capable of operating according to instructions called from a recording medium, for example, a computer. In an embodiment, the machine may be the host processor 110, the electronic device 130, or the computing systems 100, 1000 including them, according to embodiments of the present disclosure. In an embodiment, a processor of the machine may execute a called instruction to cause components of the machine to perform functions corresponding to the instruction. The recording medium may mean any kind of recording medium in which data can be stored that can be read by a machine. The recording medium may include, for example, ROM, RAM, CD-ROM, magnetic tape, floppy disk, optical data storage device, etc. In an embodiment, the recording medium may also be implemented in a distributed form in a computer system connected by a network. The software may be distributed, stored, and executed in a computer system, etc. The recording medium may be a non-transitory recording medium. A non-transitory recording medium means a tangible medium, regardless of whether data is stored semi-permanently or temporarily, and does not include a transitory propagating signal.

Although the technical idea of the present disclosure has been described by various embodiments above, the technical idea of the present disclosure includes various substitutions, modifications, and changes that can be made within the scope that can be understood by a person of ordinary skill in the art to which the present disclosure pertains. In addition, it should be understood that such substitutions, modifications, and changes may be included within the scope of the appended claims. The embodiments according to the present disclosure may be combined with each other. Each embodiment may be variously combined according to the number of cases, and the combined embodiments also belong to the scope of the present disclosure.

What is claimed is:

1. An electronic device comprising: a host processor; a volatile memory configured to store a plurality of compressed data; and a controller configured to be connected to the host processor and the volatile memory, wherein the controller is configured to generate a deduplication table that stores hash values associated with respective ones of the plurality of compressed data, identify, based on the deduplication table, first compressed data and second compressed data among the plurality of compressed data that correspond to each other, and delete one of the first compressed data and the second compressed data from the volatile memory.

2. The electronic device as claimed in claim 1, wherein the deduplication table comprises a first hash value associated with the first compressed data and a second hash value associated with the second compressed data, the controller is configured to determine whether the first hash value and the second hash value are identical, and in response to determining that the first hash value and the second hash value are identical, delete one of the first compressed data and the second compressed data from the volatile memory.

3. The electronic device as claimed in claim 2, wherein the controller is configured, in response to determining that the first hash value and the second hash value are identical, to determine whether the first compressed data and the second compressed data are identical, and in response to determining that the first compressed data and the second compressed data are identical, delete one of the first compressed data and the second compressed data from the volatile memory.

4. The electronic device as claimed in claim 2, wherein the deduplication table comprises a first counter value for the first compressed data, the controller is configured, in response to determining to delete the second compressed data, to increment the first counter value, delete the second compressed data, and delete information about the second compressed data stored in the deduplication table.

5. The electronic device as claimed in claim 1, wherein the deduplication table comprises a first entry for the first compressed data and a second entry for the second compressed data, the first entry comprises a first page address value, a first hash value, and a first counter value for the first compressed data, and the second entry comprises a second page address value, a second hash value, and a second counter value for the second compressed data.

6. The electronic device as claimed in claim 5, wherein the controller is configured to compare the first hash value and the second hash value and determine that the first hash value and the second hash value are identical, compare the first counter value and the second counter value and determine that the second counter value is less than the first counter value, delete the second compressed data from the volatile memory, increment the first counter value, and delete the second entry from the deduplication table.

7. The electronic device as claimed in claim 1, wherein the controller is configured, in response to a swap-out request for first data in units of pages received from the host processor, to store, at a first page address value of the volatile memory, first compressed data generated by compressing the first data, in response to a swap-out request for second data in units of pages received from the host processor, to store, at a second page address value of the volatile memory, second compressed data generated by compressing the second data, record the first page address value in metadata of the first data, and record the second page address value in metadata of the second data.

8. The electronic device as claimed in claim 7, wherein the controller is configured to delete the second compressed data among the first compressed data and the second compressed data, and, based on the deduplication table, change metadata of the second data from the second page address value to the first page address value.

9. The electronic device as claimed in claim 7, wherein the controller is configured, in response to a swap-out request for the first data, to generate a hash value for the first data and store the hash value in the deduplication table, and, in response to a swap-out request for the second data, generate a hash value for the second data and store the hash value in the deduplication table.

10. The electronic device as claimed in claim 9, wherein the controller is configured to generate, at intervals of a first period, the hash value for the first data or the hash value for the second data, and, at intervals of a second period different from the first period, identify, based on the deduplication table, compressed data among the plurality of compressed data that corresponds to the first compressed data or the second compressed data.

11. The electronic device as claimed in claim 1, wherein the deduplication table comprises a third entry that comprises a third page address value, a third hash value, and a third counter value for third compressed data, the controller is configured to receive, from the host processor, a swap-in request for the third compressed data stored in the volatile memory, in response to the swap-in request, provide to the host processor third data generated by decompressing the third compressed data, and change the third counter value included in the deduplication table.

12. The electronic device as claimed in claim 11, wherein the controller is configured to delete the third entry included in the deduplication table in response to changing the third counter value to 0.

13. The electronic device as claimed in claim 1, wherein the controller is further connected to a nonvolatile memory, and the deduplication table stores hash values and page address values associated with respective ones of a plurality of compressed data stored in the nonvolatile memory.

14. The electronic device as claimed in claim 13, wherein the controller is configured to determine, based on the deduplication table, whether fourth compressed data stored in the volatile memory is identical to fifth compressed data stored in the nonvolatile memory, and, in response to determining that the fourth compressed data is identical to the fifth compressed data, set a candidate flag of the fourth compressed data included in the deduplication table.

15. The electronic device as claimed in claim 14, wherein the controller is configured to determine whether a predetermined time has elapsed after the candidate flag of the fourth compressed data is set, and, in response to determining that the predetermined time has elapsed, delete the fourth compressed data from the volatile memory, delete information about the fourth compressed data included in the deduplication table, and change, based on the deduplication table, metadata associated with the fourth compressed data.

16. The electronic device as claimed in claim 13, wherein the controller is configured to determine at least one cold data item among the plurality of compressed data stored in the volatile memory and move the cold data from the volatile memory to the nonvolatile memory.

17. The electronic device as claimed in claim 1, wherein the volatile memory is divided into a compressed memory pool and a temporary memory pool, and the controller is configured to manage, based on information included in the deduplication table, data stored in the compressed memory pool.

18. A computing system comprising: a host processor; and an electronic device, wherein the electronic device comprises: a volatile memory configured to store a plurality of compressed data; and a controller configured to generate a deduplication table that stores hash values associated with respective ones of the plurality of compressed data, identify, based on the deduplication table, first compressed data and second compressed data among the plurality of compressed data that correspond to each other, and delete one of the first compressed data and the second compressed data from the volatile memory.
